(19) United States
(12) Patent Application Publication
(10) Pub. No.: US 2003/0057065 A1
(43) Pub. Date: Mar. 27, 2003

(54) Child-safe rocker switch

(76) Inventor: Steven L. Hecker, West Newton, MA (US)

Correspondence Address: DARBY & DARBY P.C., P. O. BOX 5257, NEW YORK, NY, 10150-5257, US

(21) Appl. No.: 09/963,764

(22) Filed: Sep. 26, 2001

(51) Int. Cl. H01H 9/28

(52) U.S. Cl. 200/43.16

(57) ABSTRACT

A lockable rocker switch apparatus suitable for use with or without an electrical switch includes a rocker switch actuator that is movable between at least two positions. The rocker switch apparatus also includes a locking element that is biased to a position so as to automatically lock the rocker switch actuator in a position. Once the rocker switch actuator is locked, the lock may be manually disengaged and held against the bias before the rocker switch actuator can be moved to a different position.

### FIELD OF THE INVENTION

This invention relates to electrical switch actuators.

### BACKGROUND OF THE INVENTION

Rocker switch actuators are typically designed to be easily manipulated between an off position and one or more on positions. Due to the ease with which the rocker switch actuator can move between positions, inadvertent or unwanted actuation of the switch is a recurring possibility. For example, inquisitive young children may easily manipulate most traditional rocker switch actuators to an on position, thus actuating many common household items against the wishes of their parents or supervising adults and at potential risk of creating a hazardous condition for themselves or others, or causing damage to the apparatus employing the rocker switch. Fans, heaters, high intensity light fixtures, vacuum cleaners and surge protectors for computers, televisions and audio equipment are merely a few examples of devices that use rocker switch actuators. Any of these items could be damaged or, more importantly, could cause shock or other injury to a young child if improperly actuated.

To remedy this problem, some rocker switch actuators have been designed to include a locking mechanism that prevents switch actuation if the lock is engaged. For example, U.S. Pat. No. 4,910,365 discloses a slide that may be moved to block movement of a rocker switch actuator. The patent describes that the rocker switch actuator is mounted in a housing with a hole in the housing below the rocker switch actuator. The patent further describes that the slide adjacent to the rocker switch actuator includes a latching pin such that when the slide is moved toward the rocker switch actuator, the latching pin fits in the hole below the rocker switch actuator and prevents movement of the rocker switch actuator. The patent indicates that the slide must be manually moved to lock the rocker switch actuator. In other words, the slide does not automatically lock the rocker switch actuator in any position, such as an off position.

### SUMMARY OF THE INVENTION

In one embodiment incorporating aspects of the present invention, a rocker switch apparatus includes a rocker switch actuator that is movable between at least two positions, and a lock that is biased toward a position and thus resists movement of the rocker switch actuator from a first position to a second position. In another embodiment, a rocker switch apparatus includes a rocker switch actuator that is movable between an off position and an on position, and a lock that includes a movable element and a resilient member that biases the movable element toward the rocker switch actuator. The movable element inhibits movement of the rocker switch actuator from an off position to an on position or from an on position to an off position.

In another embodiment of the present invention, a method for operating a rocker switch apparatus includes providing a rocker switch actuator in a first position, and moving the rocker switch actuator from the first position to a second position, whereby the rocker switch actuator automatically locks in the second position. In another embodiment, a method for operating a rocker switch apparatus includes providing a rocker switch actuator in a first position, and moving a movable element against a bias to allow movement of a rocker switch actuator from the first position to a second position. These and other aspects of the present invention will be apparent from the following description and appended claims.

### BRIEF DESCRIPTION OF THE DRAWINGS

Illustrative embodiments are described in connection with the following drawings, wherein:

FIG. 1 is a perspective view of a rocker switch apparatus in one position in one illustrative embodiment;

FIG. 2 is the perspective view of a rocker switch apparatus of FIG. 1 in another position in one illustrative embodiment;

FIG. 3 is a perspective view of a rocker switch actuator in one illustrative embodiment;

FIG. 4 is a perspective view of a slide lock in one illustrative embodiment;

FIG. 5 is a perspective view of a rocker switch actuator base in one illustrative embodiment; and

FIG. 6 is a side view of the rocker switch apparatus of FIG. 1.

### DETAILED DESCRIPTION

While a rocker switch apparatus including a lock that can be manually engaged to prevent movement of the rocker switch has merit, the inventor of the present invention recognized the need for improvement over such a manually lockable apparatus. In accordance with at least one aspect of the present invention, a rocker switch apparatus automatically locks in a desired position, thus adding increased security against unwanted rocker switch actuation. For purposes of describing the present invention, rocker switch actuation means movement of the rocker switch to any active or inactive (i.e., respectively, “on” or “off”) position. This automatic locking feature eliminates the need of having to remember to manually engage the rocker switch lock every time one wishes to prevent rocker switch actuation, e.g., movement of the rocker switch between different on positions, or the shutting off of the rocker switch apparatus. It should be appreciated that the rocker switch apparatus of the present invention could be used in conjunction with an electrical switch to change the electrical switch states of the corresponding electrical switch. While such a configuration could be used with an assortment of electrical devices, as is well known in the art, the rocker switch apparatus of the present invention could also be used without such an electrical switch. Any description herein that includes electrical switch devices should not be construed to limit the scope of potential applications of the present invention solely to apparatuses using electrical switches. Any application consistent with the disclosed scope of the invention is contemplated for the use of a rocker switch apparatus of the present invention.

A rocker switch apparatus that automatically locks in a position in accordance with an aspect of the present invention is an improvement over a rocker switch locking device that requires manipulation of the lock to secure the rocker switch. As stated, users of an apparatus that includes an automatically locking rocker switch actuator would not have to consciously remember to engage the rocker switch lock to prevent inadvertent manipulation of the rocker switch actuator. This inadvertent manipulation may be caused by such actions as unknowingly leaning on the rocker switch actuator, placing objects on the rocker switch actuator or otherwise applying a force to the rocker switch actuator sufficient to change its position.

In another aspect of the invention, a rocker switch actuator and lock apparatus that requires some level of manual dexterity to disengage the lock and actuate the rocker switch inhibits small children from easily actuating the rocker switch apparatus against the wishes of their parents or supervising adults. The manual dexterity required to actuate a locked rocker switch actuator of the present invention includes the ability to apply a force sufficient to disengage the rocker switch lock, and then maintain that force on the lock while simultaneously applying force to the rocker switch actuator to change actuation states, or positions. The multiple, concurrent tasks necessary to unlock and change positions of the rocker switch actuator creates an apparatus that small children would find difficult to manipulate.

One embodiment of the present invention is directed to a rocker switch apparatus and a method for operating a rocker switch apparatus that automatically locks in a given position. It should be appreciated that this can be accomplished in any of a number of ways and that the present invention is not limited to the particular configuration or techniques described below.

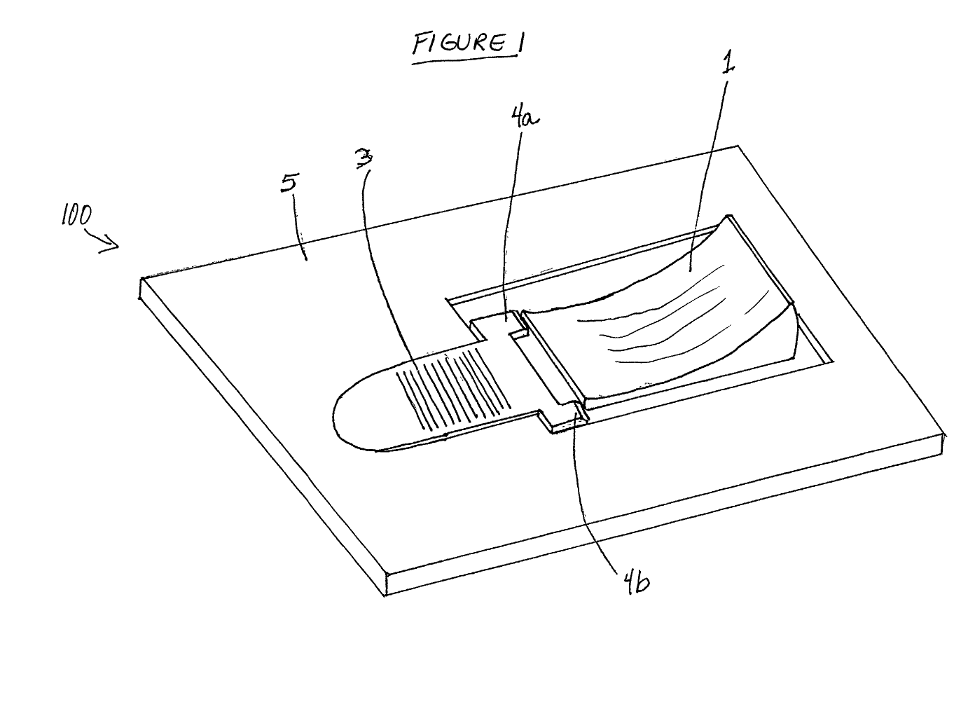

FIG. 1 is an illustrative embodiment of a rocker switch apparatus 100 in accordance with the present invention. In this illustrative embodiment, the rocker switch apparatus 100 includes a rocker switch actuator 1 that is rotatably mounted to a rocker switch base 5, and a slide lock 3 that is adjacent to the rocker switch actuator 1 and also disposed within the rocker switch base 5. As depicted in FIG. 1, the rocker switch actuator 1 has a curved top surface with one side of the top surface protruding from an opening in the top surface of the rocker switch base 5, while the other side of the rocker switch top surface is relatively flush with top surface of the rocker switch base 5. In the position depicted in FIG. 1, the rocker switch actuator is in an active, or on, position. The slide lock 3 shown in FIG. 1 has a relatively flat upper surface and is approximately the same width as the width of the top surface of the rocker switch actuator 1. Also shown on the slide lock 3 are slide lock tabs 4a, 4b that protrude from the end of the slide lock 3 closest to the rocker switch actuator 1. It should be appreciated that the shapes and relative sizes of the rocker switch actuator 1, rocker switch base 5 and slide lock 3, whether including slide lock tabs 4a, 4b or not, can be arranged different from that which is depicted in FIG. 1. For example, the top surface of the rocker switch 1 may be V-shaped or the slide lock or slide lock tabs could be cylindrical in shape, without departing from the spirit of the present invention.

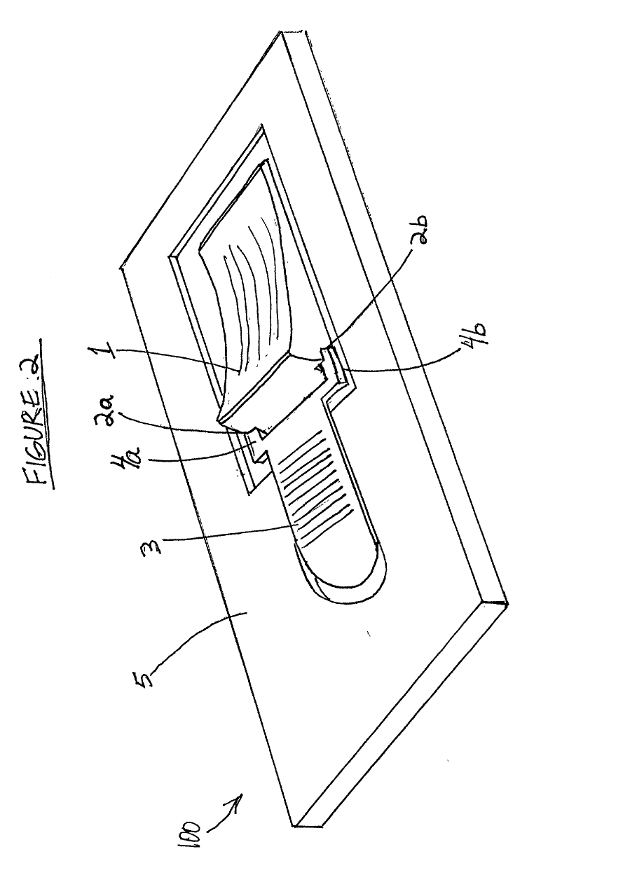

FIG. 2 shows the rocker switch actuator apparatus 100 of FIG. 1, with the rocker switch actuator 1 and slide lock 3 in different positions than shown in FIG. 1. As depicted in FIG. 2, the rocker switch actuator 1 is positioned with the side of its curved top surface closest to the slide lock 3 protruding up from the surface of the rocker switch base 5, while the other side of the rocker switch top surface is relatively flush with top surface of the rocker switch base 5. This is the opposite position of the rocker switch actuator 1 from that as depicted in FIG. 1. In the position shown in FIG. 2, the rocker switch actuator is in an inactive, or off, position.

In the embodiment shown in FIG. 2, the slide lock 3 is in a position translated forward toward the rocker switch actuator 1, compared to the relative positions of the rocker switch and slide lock shown in FIG. 1. In the embodiment of FIG. 2, the slide lock tabs 4a, 4b of the slide lock 3 mate with rocker switch notches 2a, 2b, which are visible above the surface of the rocker switch base 5 when the rocker switch actuator 1 is in the position shown in FIG. 2.

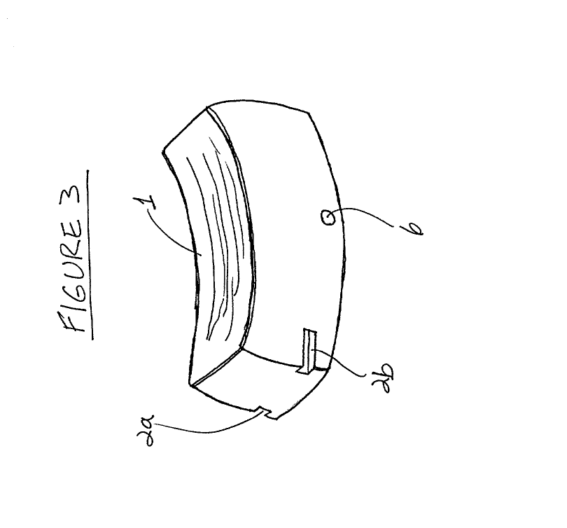

FIG. 3 shows a perspective view of the complete rocker switch actuator 1, including that portion that is positioned below the top surface of the rocker switch base 5 of FIG. 1. As shown in FIG. 3, the rocker switch comprises a pivot 6, that forms an axis of rotation about which the rocker switch actuator 1 rotates between positions. The rocker switch actuator 1 further comprises rocker switch notches 2a, 2b formed in the lateral sides of the rocker switch. The rocker switch notches 2a, 2b are sized to mate with the slide lock tabs 4a, 4b of slide lock 3. It should be appreciated that the rocker switch notches 2a, 2b may be shaped in numerous ways, so long as they are shaped to easily mate with the slide lock tabs. Furthermore, the number of slide lock tabs and rocker switch notches could be varied, from one tab and one notch to more than two tabs and two notches, so long as the number of tabs and notches was the same and they were paired and positioned so as to cooperatively engage the rocker switch with the lock. Alternatively, the notches and tabs may be omitted and the lock may resist movement of the rocker switch actuator 1 in other ways, e.g., by sliding under the rocker switch actuator 1 to prevent actuation of the rocker switch actuator 1.

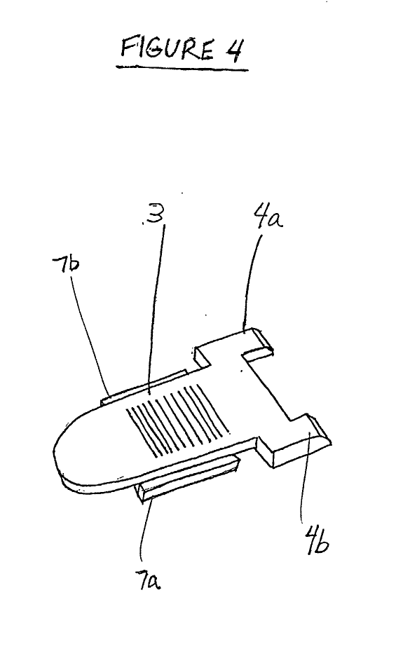

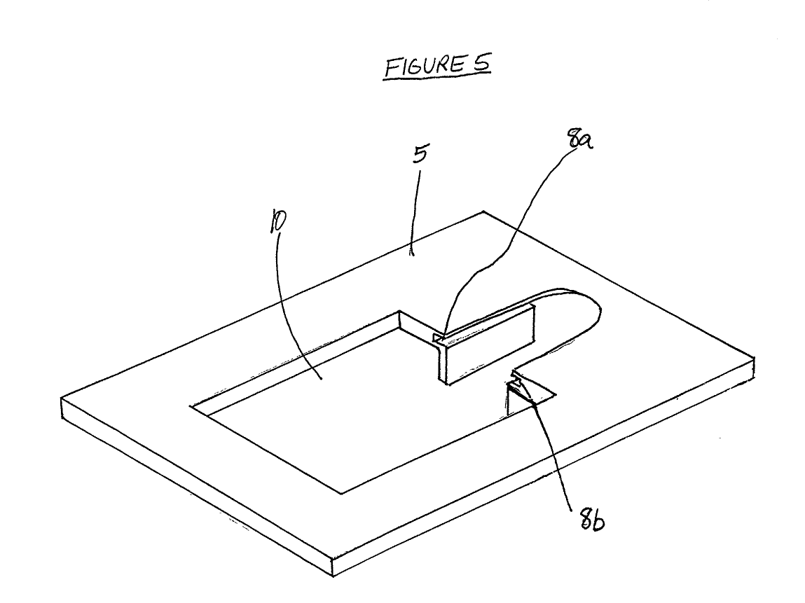

As shown in FIG. 4, the slide lock 3 further comprises slide lock rails 7a, 7b, which protrude from the lateral sides of the slide lock 3. These rails facilitate the sliding of slide lock 3 in slide lock slots 8a, 8b in the rocker switch base 5, as depicted in FIG. 5. It should be appreciated that the use of two slide lock rails to guide the movement of the slide lock is but one embodiment of the present invention. One of ordinary skill in the art could envision and implement a single slide lock rail that could also facilitate the sliding of a slide lock. Furthermore, the parallel linear tracks of the slide lock rails 7a, 7b and slide lock slots 8a, 8b, which facilitate linear movement of the slide lock 3, could be replaced by a slide lock guide configuration that allows nonlinear movement of the slide lock. The configuration of the slide lock 3, its slide lock rails 7a, 7b and the slide lock slots 8a, 8b as shown in FIGS. 4-5 is but one of numerous ways that would allow movement of a slide lock within a slide lock base.

FIG. 5 also shows one embodiment of the shape of the aperture 10 in the rocker switch base 5 that accommodates the rocker switch actuator 1 and slide lock 3 together, as in FIG. 1. As the rocker switch and lock could take various shapes and sizes within the spirit of the present invention, the rocker switch base aperture 10, likewise, could be shaped and sized in numerous ways so long as it accommodated the lock and rocker switch.

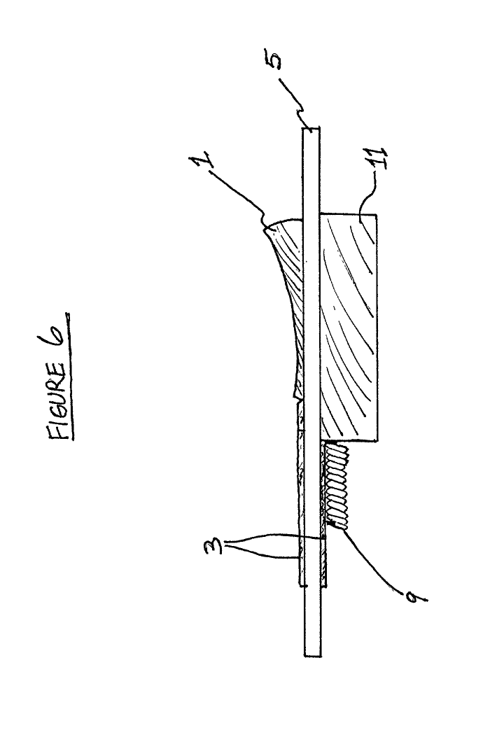

In the illustrative embodiment of FIG. 6, which is a side view of FIG. 1, the slide lock 3 further comprises a compression spring 9 mounted on the underside of slide lock 3 and against rocker switch housing 11. The compression of the spring 9 applies a force against the slide lock 3 to bias the slide lock 3 toward the rocker switch 1. It should be appreciated that one of ordinary skill in the art could implement any of a number of ways to bias the slide lock 3 toward the rocker switch. For example, the compression spring could be replaced by a torsion bar, elastomeric member, or any other means deemed suitable by one of ordinary skill in the art to provide the same bias force as the compression spring of FIG. 6.

The operation of the rocker switch apparatus will now be described for one illustrative embodiment of the invention.

As shown in FIG. 1, when the rocker switch actuator 1 is in the on position, the side of the rocker switch actuator 1 closest to the slide lock 3 is pushed down such that the rocker switch notches 2a, 2b are below the level of the slide 3 and slide lock tabs 4a, 4b. The force of the spring 9 beneath the slide lock 3 (from FIG. 6) biases the slide lock 3 against the rocker switch actuator 1, and specifically the slide lock tabs 4a, 4b to contact with the side of the rocker switch 1 closest to the slide lock 3. However, because the rocker switch notches 2a, 2b are positioned below the level of the slide lock 3 when the rocker switch actuator 1 is in the on position, the slide lock tabs 4a, 4b rest against the side surface of the rocker switch actuator 1 and are not engaged with the rocker switch notches 2a, 2b. This allows pivoting movement of the rocker switch actuator 1 from the on position without requiring manipulation of the slide lock 3.

To turn the rocker switch actuator off, sufficient force is applied to the top surface of the rocker switch actuator 1 on the side of the switch furthest from the slide lock 3 to cause the rocker switch actuator 1 to rotate about pivot 6 (in the clockwise direction of FIGS. 1 and 5). As the side of the rocker switch actuator 1 that is in contact with slide lock tabs 4a, 4b rotates above the surface of the rocker switch base 5, the rocker switch notches 2a, 2b become exposed to the slide lock tabs 4a, 4b. The force of the spring 9 biasing the slide lock 3 towards the rocker switch actuator 1 urges the slide lock tabs 4a, 4b to engage with the rocker switch notches 2a, 2b once the notches are raised to the same level as the slide lock tabs 4a, 4b. The slide lock 3 slides linearly by means of its slide lock rails 7a, 7b in slide lock slots 8a, 8b of rocker switch base 5 toward the rocker switch until the slide lock tabs 4a, 4b fully mate with the rocker switch notches 2a and 2b. At this point, the rocker switch actuator 1 is in the off position, as depicted in FIG. 2. Furthermore, the rocker switch actuator 1 is now locked in the off position due to the intervention of the slide lock 3, and specifically the mating of the slide lock tabs 4a, 4b with the rocker switch notches 2a and 2b, which prevents further movement of the rocker switch actuator 1 without removing the slide lock 3.

It should be appreciated that a slide lock does not have to be configured to move in a linear direction to engage a rocker switch, as just described. An embodiment of a rocker switch actuator with a lock could alternatively include any movable element that moves in a non-linear or rotary direction to engage, and prevent movement of, the rocker switch actuator. A slide lock that engages a rocker switch actuator from the side, as opposed to the end to end slide lock and rocker switch actuator engagement of the illustrative embodiment of FIG. 2, is another example of a configuration consistent with the scope of the present invention. One or more slide lock tabs could also be configured to engage with a rocker switch actuator in a manner that does not include mating of tabs with notches in the rocker switch, yet still engages the rocker switch actuator in such a manner as to prevent rotation of the rocker switch once the slide lock is engaged. Furthermore, the slide lock could be biased away from the rocker switch actuator, rather than toward it, to prevent movement of the rocker switch actuator. It should be appreciated that one of ordinary skill in the art could implement a rocker switch actuator and automatic lock apparatus in numerous ways consistent with the objectives of the present invention.

In one illustrative embodiment of the present invention, it is necessary to perform two distinct steps to actuate a rocker switch actuator that has been locked in an off position by a lock. These steps require the manual dexterity described previously, and may inhibit the actuation of the rocker switch apparatus by young children. Referring to FIG. 2, the first step requires manual manipulation of the slide lock 3 away from the rocker switch actuator 1 and against the force of the spring 9. As the slide lock 3 is manipulated laterally in the slide lock slots 8a, 8b away from the rocker switch actuator 1, the slide lock tabs 4a, 4b disengage from the rocker switch notches 2a and 2b. Once the slide lock tabs 4a, 4b separate completely from the rocker switch notches 2a, 2b, the rocker switch actuator 1 is freed from the constraint of the slide lock 3 and can be moved. In one illustrative embodiment, the force necessary to manipulate the slide lock 3 away from the rocker switch actuator 1 must be maintained during the second step (described below) so as to prevent the spring bias from causing the slide lock 3 to re-engage the rocker switch actuator and prevent actuation. The second step required to actuate the rocker switch actuator 1 consists of manual force applied to the top surface of the rocker switch actuator 1 on the side closest to the slide lock 3 so that the rocker switch 1 can rotate (counterclockwise in FIG. 2) about pivot 6 and move to the on position, as shown in FIG. 1. By requiring the operator of the rocker switch apparatus 100 to apply force to the slide lock 3 both prior to and while applying force to the top surface of the rocker switch actuator 1, the inventors have made it more difficult to inadvertently actuate the rocker switch actuator 1. Furthermore, small children may find it difficult to manipulate the embodiment of the invention shown in FIGS. 1-2 from an off position to an on position.

It should be appreciated that the present invention is not limited to rocker switch actuators comprising locking devices that only prevent movement of the rocker switch in one direction, e.g., from an off position to an on position, as previously described in one illustrative embodiment. The present invention could also be implemented in such a way that movement of the rocker switch from an on position to an off position is also restricted by an automatic locking mechanism, such as the slide lock described herein. Surge protectors including rocker switches are just one example of devices that would benefit from rocker switch locking mechanisms that prevent movement from an on position to an off position.

It should also be appreciated that while the embodiment of the rocker switch apparatus described herein comprises a two position rocker switch, an on position and an off position, the present invention is not limited to a two position rocker switch actuator. A rocker switch actuator including more than two actuator positions is also contemplated by the present invention. An embodiment of the invention with more than two actuator positions may include a rocker switch with engagable notches or any other suitable features that correspond with each actuator position and are used to automatically lock the rocker switch in any position of the actuator. Alternatively, an embodiment of the present invention may be configured to allow free movement between multiple on positions, only restricting movement from an off position to one of the on positions. One of ordinary skill in the art could implement any number of variations of this automatically lockable rocker switch consistent with the objectives of the present invention.

While the invention has been described in conjunction with specific embodiments, many alternatives, modifications and variations will be apparent to those skilled in the art. Accordingly, embodiments as set forth herein are intended to be illustrative of the various aspects of the invention, not limiting. Various changes may be made without departing from the scope and spirit of the invention.

1. A method for operating a rocker switch apparatus, comprising:
providing a rocker switch actuator adapted to move between first and second positions; and
providing a lock including a movable element that is biased toward a position in which the movable element resists movement of the rocker switch actuator from the first position to the second position.

2. The method of claim 1, wherein the first position is an inactive position and the second position is an active position.

3. The method of claim 1, wherein the movable element is biased toward the actuator.

4. The method of claim 1, further comprising the step of moving the rocker switch actuator from the second position to the first position to automatically lock the rocker switch actuator in the first position.

5. The method of claim 4, further comprising the steps of:
providing the rocker switch actuator locked in the first position; and
moving the movable element against the bias to unlock the rocker switch actuator to allow movement of the rocker switch actuator from the first position to the second position.

6. A method for operating a rocker switch apparatus, comprising:
providing a rocker switch actuator in a first position; and
moving the rocker switch actuator from the first position to a second position whereby the rocker switch actuator automatically locks in the second position.

7. The method of claim 6, further comprising the step of providing the rocker switch actuator in an unlocked position prior to moving the rocker switch actuator.

8. The method of claim 6, further comprising providing a lock including a movable element that is biased toward and automatically engages with the rocker switch actuator to prevent movement of the rocker switch actuator from the second position.

9. The method of claim 6, wherein the first position is an active position and the second position is an inactive position.

10. A method for operating a rocker switch apparatus comprising:
providing a rocker switch actuator in a first position; and
moving a movable element against a bias to allow movement of the rocker switch actuator from the first position to a second position.

11. The method of claim 10, further comprising the step of disengaging the movable element from the rocker switch actuator.

12. The method of claim 10, wherein the first position is an inactive position and the second position is an active position.

13. A rocker switch apparatus, comprising:
a rocker switch actuator that is movable between a first position and a second position; and
a lock including a movable element that is biased toward a position in which the movable element resists movement of the rocker switch actuator from the first position to the second position.

14. The apparatus of claim 13, wherein the lock does not resist movement of the rocker switch actuator from the second position to the first position.

15. The apparatus of claim 13, wherein the lock includes a slot in which the movable element moves.

16. The apparatus of claim 15, wherein the movable element is a slide.

17. The apparatus of claim 16, wherein the slide is adapted for linear movement in the slot.

18. The apparatus of claim 17, wherein the slide is biased toward the rocker switch actuator.

19. The apparatus of claim 18, further comprising a spring that biases the slide.

20. The apparatus of claim 19, wherein the spring is disposed with the slide.

21. The apparatus of claim 20, wherein the slide prevents movement of the rocker switch actuator from the first position to the second position.

22. The apparatus of claim 21, wherein the slide automatically engages the rocker switch actuator in the first position to prevent movement of the rocker switch actuator from the first position to the second position.

23. The apparatus of claim 22, wherein a tab included in the slide automatically engages a slot included in the rocker switch actuator to prevent movement of the rocker switch actuator from the first position to the second position.

24. The apparatus of claim 23, wherein the slide is movable against the bias to disengage the slide including a tab from the rocker switch actuator including a slot and allow movement of the rocker switch actuator from the first position to the second position.

25. The apparatus of claim 24, wherein the first position is an inactive position and the second position is an active position.

26. A rocker switch apparatus comprising:
a rocker switch actuator, including a slot, which is movable between an off position and an on position; and
a lock including a movable element and a resilient member that biases the movable element toward the rocker switch actuator to a position in which the movable element inhibits movement of the rocker switch actuator from one of the off position and the on position to the other of the off position and the on position.

27. The apparatus of claim 26, wherein the resilient member is a spring.

28. The apparatus of claim 26, wherein the movable element is a slide adapted for linear movement in the lock.

29. The apparatus of claim 28, wherein the slide includes a tab that engages the slot of the rocker switch actuator in the off position to prevent movement of the rocker switch actuator from the off position to an on position.

30. The apparatus of claim 29, wherein the rocker switch actuator includes two slots and the slide includes two tabs that engage the slots of the rocker switch actuator in the off position to prevent movement of the rocker switch actuator from the off position to an on position.

31. The apparatus of claim 30, wherein the slide is constructed and arranged to be movable against the spring bias to disengage the slide including the tabs from the rocker switch actuator including the slots and allow movement of the rocker switch actuator from the off position to an on position.
